(19) United States
(12) Patent Application Publication
(10) Pub. No.: US 2014/0233257 A1
(43) Pub. Date: Aug. 21, 2014

(54) LIGHT EMITTING MODULE APPLIED TO DISPLAY DEVICE

(71) Applicant: AU Optronics Corp., Hsin-Chu (TW)

(72) Inventor: Chieh-Jen Cheng, Hsin-Chu (TW)

(73) Assignee: AU Optronics Corp., Hsin-Chu (TW)

(21) Appl. No.: 14/045,805

(22) Filed: Oct. 4, 2013

(30) Foreign Application Priority Data
Feb. 19, 2013 (TW) 102105737

(51) Int. Cl. F21V 23/00; F21V 8/00

(52) U.S. Cl. CPC F21V 23/001; G02B 6/0035
USPC 362/606; 362/249.01; 362/249.02

(57) ABSTRACT

A light emitting module includes a first circuit board, a driver chip, two connectors, a second circuit board and a plurality of light emitting units. The driver chip is disposed on the first circuit board. The two connectors are disposed on the first circuit board and electrically connected to the driver chip. The second circuit board has two groups of connecting cables and each group of connecting cables is electrically connected to one of the two connectors. The light emitting units are disposed on the second circuit board and electrically connected to the two groups of connecting cables.

### BACKGROUND OF THE INVENTION

1. Field of the Invention

The invention relates to a light emitting module and, more particularly, to a light emitting module adapted for a display device with a narrow bezel.

2. Description of the Prior Art

Referring to FIG. 1, FIG. 1 is a top view illustrating a light emitting module 1 of the prior art. The light emitting module 1 is adapted for a backlight module of a display device. As shown in FIG. 1, the light emitting module 1 comprises a printed circuit board (PCB) 10, a connector 12, a flexible printed circuit board (FPC) 14 and a plurality of light emitting diodes 16. The connector 12 is disposed on the PCB 10. The FPC 14 has one group of connecting cables 140 and one end of the group of connecting cables 140 is electrically connected to the connector 12. The light emitting diodes 16 are disposed on the FPC 14 and electrically connected to the other end of the group of connecting cables 140.

In the conventional light emitting module 1, the connector 12 disposed on the PCB 10 has ten connecting pins for electrically connecting a certain number of light emitting diodes 16 through the group of connecting cables 140, so as to provide sufficient light for a display panel. In general, a width W1 of the connector 12 with ten connecting pins is about 8 mm, such that a width W2 of the PCB increases correspondingly (e.g. 10 mm). Since the display device tends to thinned size, the PCB 10 of the conventional light emitting module 1 is usually disposed at one side of the display panel. Consequently, a width of a bezel increases due to the width W2 of the PCB 10, such that the conventional light emitting module 1 cannot be adapted for a display device with a narrow bezel.

### SUMMARY OF THE INVENTION

An objective of the invention is to provide a light emitting module adapted for a display device with a narrow bezel, so as to solve the aforesaid problems.

According to an embodiment of the invention, a light emitting module comprises a first circuit board, a driver chip, two connectors, a second circuit board and a plurality of light emitting units. The driver chip is disposed on the first circuit board. The two connectors are disposed on the first circuit board and electrically connected to the driver chip. The second circuit board has two groups of connecting cables and each group of connecting cables is electrically connected to one of the two connectors. The light emitting units are disposed on the second circuit board and electrically connected to the two groups of connecting cables.

According to another embodiment of the invention, a display device comprises a frame, a backlight module and a display panel. The backlight module is disposed in the frame. The backlight module comprises the aforesaid light emitting module, a light guide plate and an optical film assembly. The light emitting units are located at a side of the light guide plate. The optical film assembly is disposed on the light guide plate. The display panel is disposed in the frame and located on the backlight module.

As mentioned in the above, the invention disposes two connectors on the first circuit board and the two connectors are electrically connected to the light emitting units on the second circuit board through two groups of connecting cables. In other words, the invention replaces a single large connector of the prior art (e.g. the one has ten connecting pins) with two small connectors (e.g. each one has six connecting pins), so as to reduce a width of the first circuit board. Consequently, a width of a bezel of the display device can be reduced. Therefore, the light emitting module of the invention can be adapted for a display device with a narrow bezel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a top view illustrating a light emitting module of the prior art.

FIG. 2 is a partial cross-sectional view illustrating a display device according to an embodiment of the invention.

FIG. 3 is a top view illustrating a light emitting module according to an embodiment of the invention.

FIG. 4 is a top view illustrating a light emitting module according to another embodiment of the invention.

FIG. 5 is a top view illustrating a light emitting module according to another embodiment of the invention.

FIG. 6 is a cross-sectional view illustrating the first circuit board along line X-X shown in FIG. 5.

### DETAILED DESCRIPTION

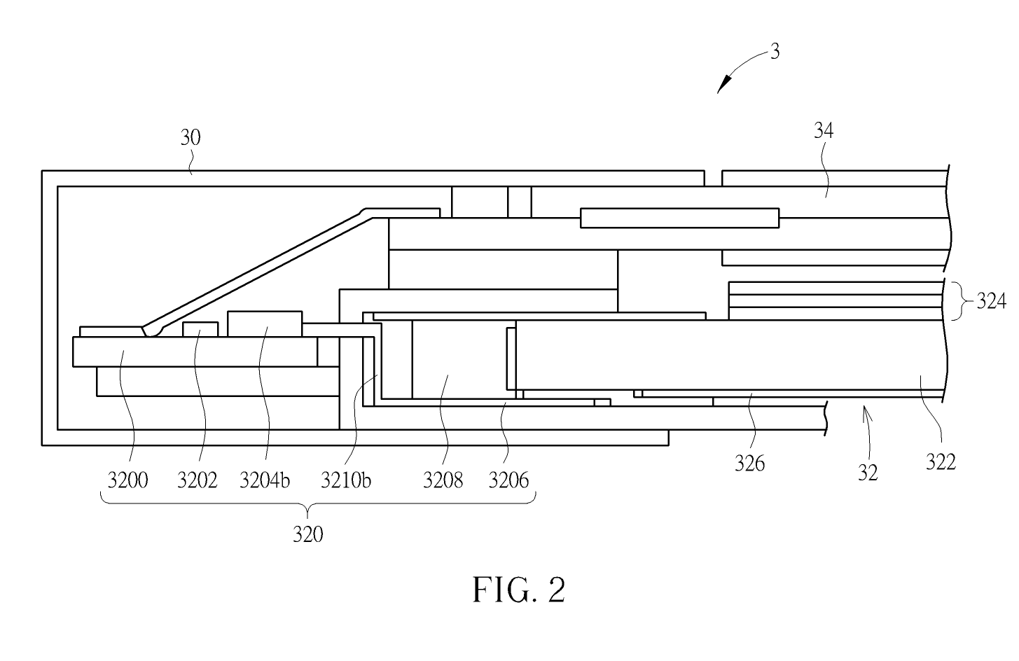

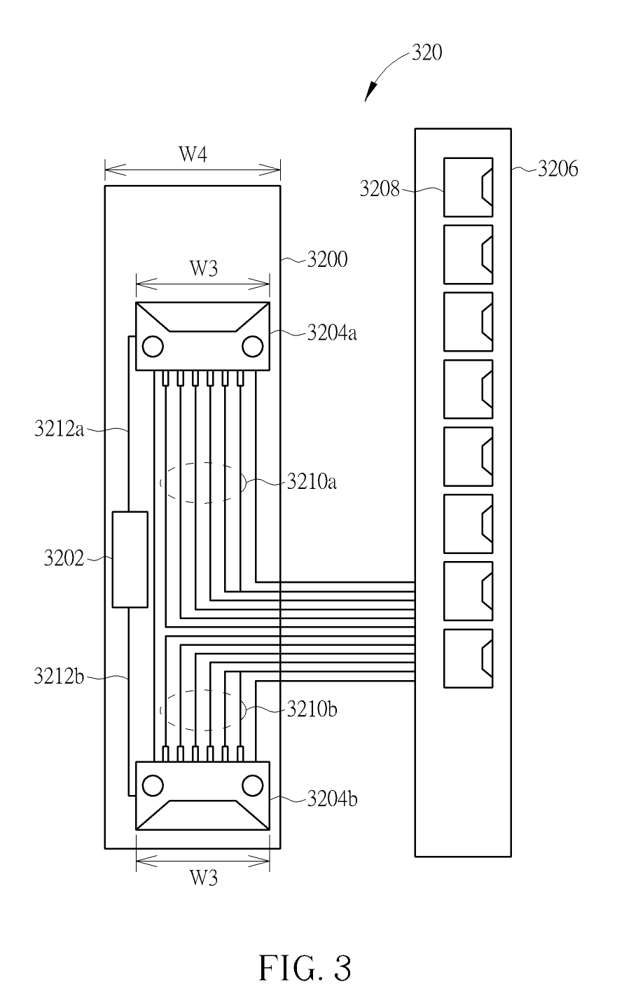

Referring to FIGS. 2 and 3, FIG. 2 is a partial cross-sectional view illustrating a display device 3 according to an embodiment of the invention, and FIG. 3 is a top view illustrating a light emitting module 320 according to an embodiment of the invention. As shown in FIG. 2, the display device 3 comprises a frame 30, a backlight module 32 and a display panel 34. The display panel 34 maybe a liquid crystal display panel or other display panels according to practical applications. The backlight module 32 and the display panel 34 are disposed in the frame 30. The display panel 34 is located on the backlight module 32. The backlight module 32 comprises a light emitting module 320, a light guide plate 322, an optical film assembly 324 and a reflective sheet 326, wherein the optical film assembly 324 is disposed on the light guide plate 322 and the reflective sheet 326 is disposed below the light guide plate 322 correspondingly. The optical film assembly 324 may comprise a plurality of optical films, such as prism sheets, diffusion sheets, and so on. The number, type and configuration of the optical films can be determined according to practical applications. The light emitting module 320 cooperates with the light guide plate 322 to provide sufficient light for the display panel 34. The optical film assembly 324 is used for improving optical characteristics of light and the reflective sheet 326 is used for reflecting light.

As shown in FIGS. 2 and 3, the light emitting module 320 comprises a first circuit board 3200, a driver chip 3202, two connectors 3204a, 3204b, a second circuit board 3206 and a plurality of light emitting units 3208. The driver chip 3202 is disposed on the first circuit board 3200 and used for actuating the light emitting units 3208. The two connectors 3204a, 3204b are disposed on the first circuit board 3200 and electrically connected to the driver chip 3202. The second circuit board 3206 has two groups of connecting cables 3210a, 3210b, and each group of connecting cables 3210a, 3210b is electrically connected to one of the two connectors 3204a, 3204b. The light emitting units 3208 are disposed on the second circuit board 3206 and electrically connected to the two groups of connecting cables 3210a, 3210b. Each group of connecting cables 3210a, 3210b comprises at least one connecting cables and the number of connecting cables are not limited in the invention. Furthermore, the light emitting units 3208 is located at a side of the light guide plate 322. In this embodiment, the first circuit board 3200 may be, but not limited to, a printed circuit board (PCB), the second circuit board 3206 may be, but not limited to, a flexible printed circuit board (FPC), and each of the light emitting units 3208 may be, but not limited to, a light emitting diode (LED).

As shown in FIG. 3, the two connectors 3204a, 3204b are located at opposite sides of the two groups of connecting cables 3210a, 3210b, such that each group of connecting cables 3210a, 3210b forms an L shape and the two groups of connecting cables 3210a, 3210b together form a T shape. In another embodiment, each group of connecting cables 3210a, 3210b may form an L shape only without T shape. Furthermore, the driver chip 3202 is located at an appropriate position between the two connectors 3204a, 3204b, such that circuit resistance of two circuit layouts 3212a, 3212b between the two connectors 3204a, 3204b and the driver chip 3202 is substantially identical. Accordingly, the driver chip 3202 can actuate all of the light emitting units 3208 simultaneously.

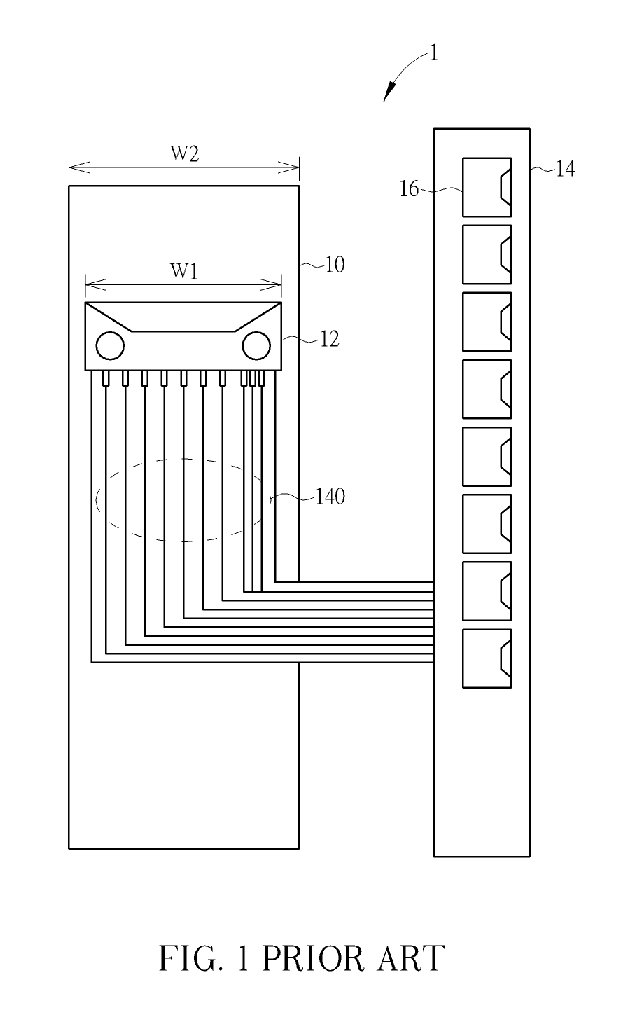

In this embodiment, each of the two connectors 3204a, 3204b may has six connecting pins for electrically connecting the light emitting units 3208 on the second circuit board 3206 through the two groups of connecting cables 3210a, 3210b. In general, a width W3 of each of the two connectors 3204a, 3204b with six connecting pins is about 4 mm, such that a width W4 of the first circuit board 3200 can be reduced to 7 mm or less, so as to reduce a width of a bezel of the frame 30 of the display device 3. In other words, the invention replaces a single large connector 12 of the prior art (e.g. the one has ten connecting pins) with two small connectors 3204a, 3204b (e.g. each one has six connecting pins), so as to reduce the width W4 of the first circuit board 3200. Consequently, a width of the bezel of the display device 3 can be reduced. It should be noted that the number of connecting cables of each connector 3204a, 3204b are not limited to six. As long as the number of connecting pins of each connector 3204a, 3204b are less than those of the connector 12 of the prior art (as shown in FIG. 1), the width W3 of each connector 3204a, 3204b is smaller than the width W1 of the connector 12 of the prior art, such that the width W4 of the first circuit board 3200 is reduced accordingly.

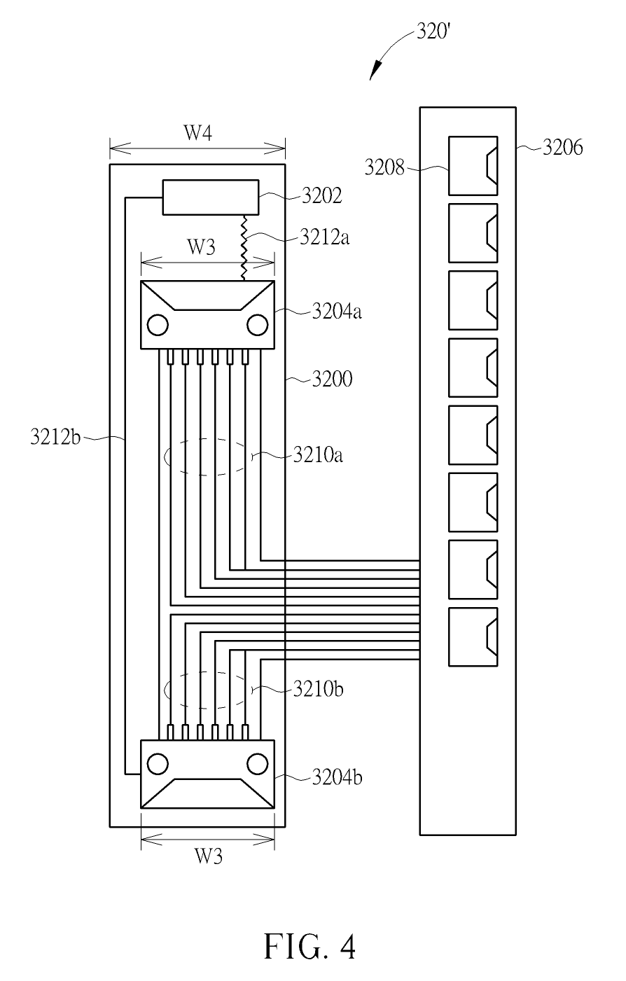

Referring to FIG. 4, FIG. 4 is a top view illustrating a light emitting module 320′ according to another embodiment of the invention. The main difference between the light emitting module 320′ and the aforesaid light emitting module 320 is that the driver chip 3202 of the light emitting module 320′ is located at a side of the two connectors 3204a, 3204b and a circuit layout 3212a between the driver chip 3202 and the connector 3204a, which is close to the driver chip 3202, is a wire-wound structure, such that circuit resistance of two circuit layouts 3212a, 3212b between the two connectors 3204a, 3204b and the driver chip 3202 is substantially identical. Accordingly, the driver chip 3202 can actuate all of the light emitting units 3208 simultaneously. The circuit layout 3212a shown in FIG. 4 is formed as, but not limited to, a saw-toothed shape. In another embodiment, the circuit layout 3212a may also be formed as a waved shape, a convex-concave shape, or other winding shapes according to practical applications. It should be noted that the same elements in FIG. 4 and FIG. 3 are represented by the same numerals, so the repeated explanation will not be depicted herein again.

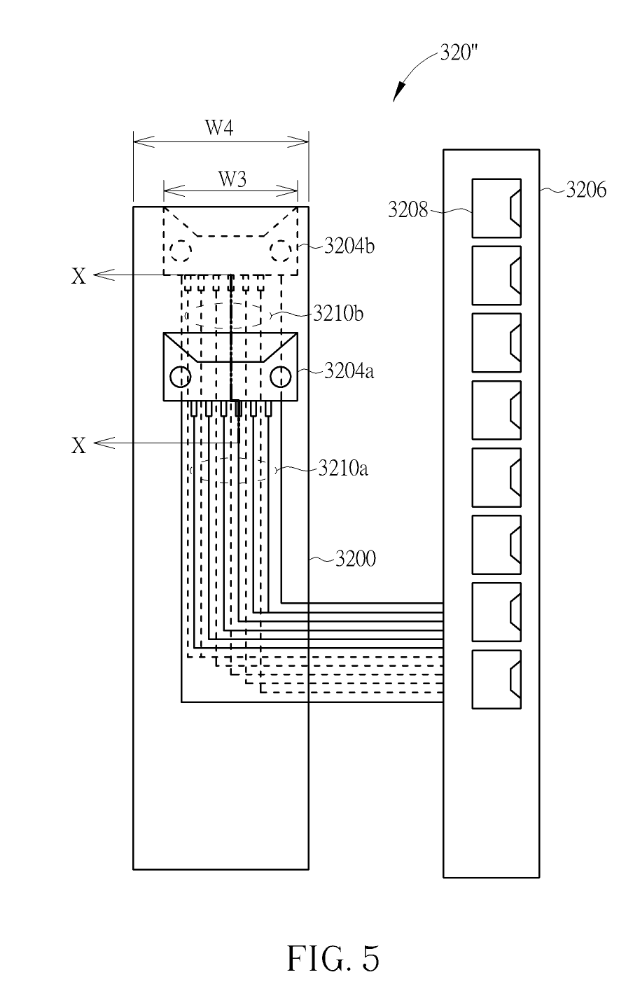

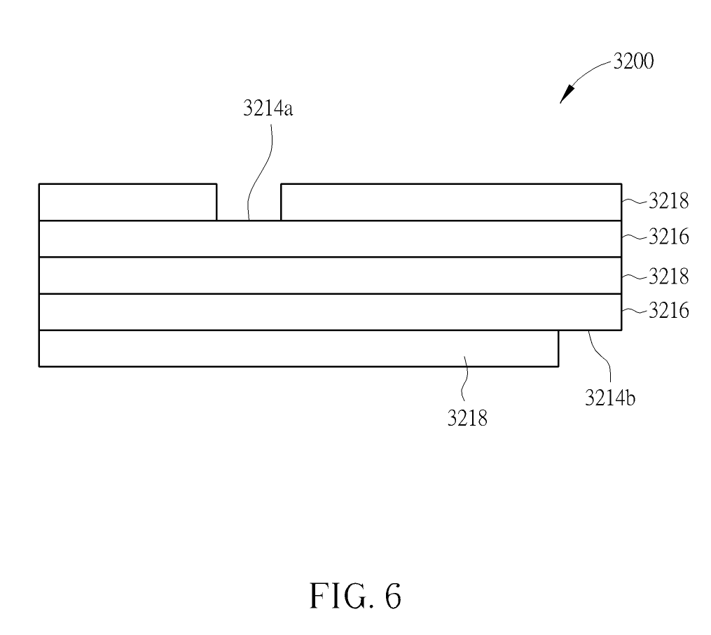

Referring to FIGS. 5 and 6, FIG. 5 is a top view illustrating a light emitting module 320″ according to another embodiment of the invention, and FIG. 6 is a cross-sectional view illustrating the first circuit board 3200 along line X-X shown in FIG. 5. The main difference between the light emitting module 320″ and the aforesaid light emitting module 320 is that the two connectors 3204a, 3204b of the light emitting module 320′ are located at an identical side of the two groups of connecting cables 3210a, 3210b and located at top and bottom sides of the first circuit board 3200, such that each group of connecting cables 3210a, 3210b forms an L shape. In FIG. 5, the connector 3204b located at the bottom of the first circuit board 3200 is represented by dot lines. As shown in FIG. 6, several connecting pads 3214a, 3214b of the two groups of connecting cables 3210a, 3210b are exposed and used for connecting the two connectors 3204a, 3204b located at top and bottom sides of the first circuit board 3200. Furthermore, the aforesaid driver chip 3202 (not shown in FIG. 5) may be disposed at an appropriate position of the first circuit board 3200, such that circuit resistance of two circuit layouts between the two connectors 3204a, 3204b and the driver chip 3202 is substantially identical. In general, the first circuit board 3200 may essentially consist of a conducting layer 3216 (e.g. copper foil) and an insulating layer 3218 (e.g. PET). The structure of the circuit board is well known by one skilled in the art, so the related art will not be depicted herein. It should be noted that the same elements in FIG. 5 and FIG. 3 are represented by the same numerals, so the repeated explanation will not be depicted herein again.

Compared with the prior art, the invention disposes two connectors on the first circuit board and the two connectors are electrically connected to the light emitting units on the second circuit board through two groups of connecting cables. In other words, the invention replaces a single large connector of the prior art (e.g. the one has ten connecting pins) with two small connectors (e.g. each one has six connecting pins), so as to reduce a width of the first circuit board. Consequently, a width of a bezel of the display device can be reduced. Therefore, the light emitting module of the invention can be adapted for a display device with a narrow bezel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light emitting module comprising:
a first circuit board;
a driver chip disposed on the first circuit board;
two connectors disposed on the first circuit board and electrically connected to the driver chip;
a second circuit board having two groups of connecting cables, each group of connecting cables being electrically connected to one of the two connectors; and
a plurality of light emitting units disposed on the second circuit board and electrically connected to the two groups of connecting cables.

2. The light emitting module of claim 1, wherein the two connectors are located at opposite sides of the two groups of connecting cables, such that each group of connecting cables forms an L shape and the two groups of connecting cables together form a T shape.

3. The light emitting module of claim 1, wherein the two connectors are located at opposite sides of the two groups of connecting cables, such that each group of connecting cables forms an L shape.

4. The light emitting module of claim 1, wherein the two connectors are located at an identical side of the two groups of connecting cables and located at top and bottom sides of the first circuit board, such that each group of connecting cables forms an L shape.

5. The light emitting module of claim 1, wherein the driver chip is located between the two connectors, such that circuit resistance of two circuit layouts between the two connectors and the driver chip is substantially identical.

6. The light emitting module of claim 1, wherein the driver chip is located at a side of the two connectors and a circuit layout between the driver chip and one of the two connectors, which is close to the driver chip, is a wire-wound structure, such that circuit resistance of two circuit layouts between the two connectors and the driver chip is substantially identical.

7. The light emitting module of claim 1, wherein the second circuit board is a flexible printed circuit board.

8. The light emitting module of claim 1, wherein each of the two connectors has six connecting pins.

9. The light emitting module of claim 1, wherein each of the light emitting units is a light emitting diode.

10. A display device comprising:
a frame;
a backlight module disposed in the frame, the backlight module comprising:
a light emitting module comprising:
a first circuit board;
a driver chip disposed on the first circuit board;
two connectors disposed on the first circuit board and electrically connected to the driver chip;
a second circuit board having two groups of connecting cables, each group of connecting cables being electrically connected to one of the two connectors; and
a plurality of light emitting units disposed on the second circuit board and electrically connected to the two groups of connecting cables;
a light guide plate, the light emitting units being located at a side of the light guide plate; and
an optical film assembly disposed on the light guide plate; and
a display panel disposed in the frame and located on the backlight module.

11. The display device of claim 10, wherein the two connectors are located at opposite sides of the two groups of connecting cables, such that each group of connecting cables forms an L shape and the two groups of connecting cables together form a T shape.

12. The display device of claim 10, wherein the two connectors are located at opposite sides of the two groups of connecting cables, such that each group of connecting cables forms an L shape.

13. The display device of claim 10, wherein the two connectors are located at an identical side of the two groups of connecting cables and located at top and bottom sides of the first circuit board, such that each group of connecting cables forms an L shape.

14. The display device of claim 10, wherein the driver chip is located between the two connectors, such that circuit resistance of two circuit layouts between the two connectors and the driver chip is substantially identical.

15. The display device of claim 10, wherein the driver chip is located at a side of the two connectors and a circuit layout between the driver chip and one of the two connectors, which is close to the driver chip, is a wire-wound structure, such that circuit resistance of two circuit layouts between the two connectors and the driver chip is substantially identical.

16. The display device of claim 10, wherein the second circuit board is a flexible printed circuit board.

17. The display device of claim 10, wherein each of the two connectors has six connecting pins.

18. The display device of claim 10, wherein each of the light emitting units is a light emitting diode.
